(19) United States
(12) Patent Application Publication
(10) Pub. No.: US 2025/0241295 A1
(43) Pub. Date: Jul. 31, 2025

(54) MEMBRANE-LESS EX VIVO LUNG PERFUSION

(71) Applicant: University Health Network, Toronto (CA)

(72) Inventors: Aizhou WANG, Toronto (CA); Guillermo Oscar GARZA, Toronto (CA); Marcelo CYPEL, Toronto (CA); Shafique KESHAVJEE, Toronto (CA)

(73) Assignee: University Health Network, Toronto, ON (CA)

(21) Appl. No.: 19/041,372

(22) Filed: Jan. 30, 2025

Related U.S. Application Data
(60) Provisional application No. 63/627,667, filed on Jan. 31, 2024.

(51) Int. Cl. A01N 1/143; A01N 1/144; A01N 1/162

(52) U.S. Cl. CPC A01N 1/143; A01N 1/144; A01N 1/162

(57) ABSTRACT

An ex-vivo lung perfusion (EVLP) method may include ventilating a donor lung with a gas mixture that comprises carbon dioxide and circulating a perfusate through a perfusion circuit and the donor lung while ventilating the donor lung. The perfusion circuit does not have a membrane gas exchanger.

### CROSS-REFERENCE TO RELATED APPLICATIONS

This application claims the benefit of U.S. Provisional Application No. 63/627,667, filed Jan. 31, 2024, the entire contents of which are incorporated herein by reference.

### FIELD

The present disclosure relates generally to donor lung preservation techniques, in particular to ex vivo lung perfusion techniques.

### BACKGROUND

The field of organ transplantation faces numerous challenges that have significant impacts on organ donation outcomes. These challenges include improving organ preservation and assessing and repairing functionality in donor organs in order to increase the quantity and quality of available donor organs and reduce transplant wait lists. Ex vivo organ perfusion (EVOP) is often performed to address these challenges. EVOP involves pumping a nutrient-rich fluid (a perfusate) through a donor organ. This can help preserve the organ for a longer period of time prior to transplantation and can allow for a functional assessment of the organ prior to transplantation.

Systems that are used to perform EVOP may be organ specific. For example, ex vivo lung perfusion (EVLP) systems are used to perfuse a donor lung ex-vivo prior to transplantation into a recipient. EVLP systems conventionally utilize a membrane gas exchanger to maintain the level of carbon dioxide in the perfusate by supplying a deoxygenating gas mixture to the perfusate. Membrane gas exchangers typically include a membrane of hollow fibers, at which gas exchange can take place between the supplied gas mixture and the perfusate. Typically, the membrane gas exchanger also warms the perfusate to near-physiological temperatures to achieve normothermic perfusion. EVLP systems conventionally also include a ventilator to supply oxygen to the donor lung.

### SUMMARY

Described herein are ex vivo lung perfusion (EVLP) systems and methods that deliver carbon dioxide to a perfusate by ventilating a donor organ with a gas mixture that includes carbon dioxide as the perfusate is circulated through the donor organ. Providing the carbon dioxide to the perfusate via ventilation of the donor organ allows for the elimination of a membrane gas exchanger from the perfusion circuit. Eliminating the membrane gas exchanger from the perfusion circuit and/or providing carbon dioxide via ventilation of the donor organ may allow the donor organ to be perfused for a prolonged period (e.g., greater than six hours). The provided techniques may facilitate the addition of red blood cells and various therapies (e.g., drugs such as antibiotics, stem cells, gene therapies, etc.) to the perfusate, which may contribute to prolonging perfusion and allowing diseased or damaged donor organs that would otherwise be unsuitable for transplantation to be repaired and transplanted into a recipient.

For example, exposing the perfusate to artificial surfaces such as those of a membrane gas exchanger can be detrimental to red blood cells in the perfusate and may also cause cell activation and inflammatory responses. Membrane gas exchangers can also remove or reduce beneficial drugs or stem cells that physicians may wish to add to the perfusate. So, removing the membrane gas exchanger from an EVLP system may enable the inclusion of red blood cells in the perfusate and/or may increase the beneficial effects of drugs and/or stem cells in the perfusate, which may allow the donor organ to be perfused for a prolonged period.

An EVLP method may include ventilating a donor lung with a gas mixture that comprises carbon dioxide and circulating a perfusate through a perfusion circuit and the donor lung while ventilating the donor lung. The perfusion circuit may not have a membrane gas exchanger. In some examples, the gas mixture may include 5% to 10% carbon dioxide, for instance, 8% carbon dioxide. In some examples, the gas mixture includes 20-23% oxygen, for instance, 21% oxygen. In some examples, the gas mixture includes 65-75% nitrogen, for instance, 71% nitrogen. In some examples, the method comprises measuring one or more gas levels in the perfusate. The composition of the gas mixture (e.g., the gases present in the gas mixture and/or their respective percentages) or a flow rate of the gas mixture through the donor lung may be adjusted based on the measured one or more gas levels.

In some examples, the method may include warming the perfusate, for example, to a temperature of 34-40° C., dialyzing the perfusate, refrigerating the donor lung, and/or filtering the perfusate. In some examples, the method includes transporting the donor lung from a donor site to a perfusion site. In some examples, the perfusate includes a cellular component, for instance, red blood cells. In some examples, the method may include receiving, at the ventilator, a hypoxic gas mixture from a medical air supply and an oxygen gas mixture from an oxygen supply, and combining the hypoxic gas mixture with the oxygen gas mixture to create the gas mixture that comprises carbon dioxide.

An EVLP system may include a ventilator for controlling a composition of, and ventilating a donor lung with, a gas mixture comprising carbon dioxide; a perfusion circuit connected to the donor lung for flowing perfusate through the donor lung that does not have a membrane gas exchanger, and a pump for circulating the perfusate through the perfusion circuit and donor lung while the donor lung is being ventilated.

The ventilator of the EVLP system may be configured to control the composition of the gas mixture such that the gas mixture comprises 5% to 10% carbon dioxide, for instance, 8% carbon dioxide. The ventilator of the EVLP system may be configured to control the composition of the gas mixture such that the gas mixture comprises 20% to 23% oxygen, for instance, 21% oxygen. The ventilator of the EVLP system may be configured to control the composition of the gas mixture such that the gas mixture comprises 65% to 75% nitrogen, for instance, 71% nitrogen. In some examples, the ventilator may be configured to control the composition of the gas mixture by combining a hypoxic gas mixture from a medical air supply with an oxygen gas mixture from an oxygen supply. The hypoxic gas mixture may include about 6-8% oxygen and about 6-8% carbon dioxide, in order to supply carbon dioxide to the perfusion circuit without the use of a membrane gas exchanger. The oxygen gas mixture may include 25-35% oxygen so as to offset the low amount of oxygen in the hypoxic gas mixture, such that the percentage of oxygen in the gas mixture that leaves the ventilator is approximately 21%.

The system can also include one or more sensors configured to measure one or more gas levels in the perfusate. A controller can be coupled to the one or more sensors and a gas mixture source and configured to adjust one or more gas levels in the gas mixture based on the measured one or more gas levels in the perfusate. The controller can also be connected to the one or more sensors and the ventilator and configured to adjust a flow rate of the gas mixture through the donor lung based on the measured one or more gas levels. In some examples, gas levels in the perfusate may be measured using a blood gas machine that includes the sensors, and the ventilator may have a built-in controller for regulating the composition of the gas mixture. In some examples, the system includes a heater for warming the perfusate to a temperature of 34-40° C., a dialysis system for dialyzing the perfusate, and/or a filter for filtering the perfusate. In some examples, the filter is configured to filter a perfusate that includes a cellular component, for instance, red blood cells.

### BRIEF DESCRIPTION OF THE FIGURES

The following figures show various ex vivo lung perfusion systems and methods, along with example data showing potential benefits of the provided ex vivo lung perfusion methods. The systems and methods shown in the figures may have any one or more of the characteristics described herein.

FIG. 1 shows an ex vivo lung perfusion (EVLP) system, according to some embodiments.

FIG. 2 shows an EVLP method, according to some embodiments.

FIG. 3A shows the design of an example porcine ex vivo lung perfusion (EVLP) experiment.

FIG. 3B shows dynamic compliance data collected during an example porcine EVLP experiment.

FIG. 3C shows dynamic compliance data collected during an example porcine EVLP experiment.

FIG. 3D shows oxygenation data collected during an example porcine EVLP experiment.

FIG. 3E shows oxygenation data collected during an example porcine EVLP experiment.

FIG. 3F shows lactate data collected during an example porcine EVLP experiment.

FIG. 3G shows lactate data collected during an example porcine EVLP experiment.

FIG. 3H shows perfusate IL-6 data collected during an example EVLP experiment.

FIG. 4 shows an ex vivo lung perfusion (EVLP) system, according to some embodiments.

### DETAILED DESCRIPTION

Described herein are ex vivo lung perfusion (EVLP) systems and methods that can deliver carbon dioxide to a perfusate by ventilating the donor lung with a gas mixture as the perfusate is circulated through the donor lung. Providing a deoxygenating gas, such as carbon dioxide to the perfusate via ventilation of the donor lung can allow for the elimination from the perfusion circuit (or bypassing) of a membrane gas exchanger (also commonly referred to as a membrane oxygenator/deoxygenator) conventionally used for controlling the oxygen and/or carbon dioxide concentrations in the perfusate. It was advantageously found that ventilating the donor lung with carbon dioxide instead of using a membrane gas exchanger is safe and effective for use with cellular perfusates.

Eliminating the membrane gas exchanger from the perfusion circuit may have a number of benefits. Exposing the perfusate to artificial surfaces such as a membrane gas exchanger can be detrimental. In particular, a membrane gas exchanger may limit or prevent the incorporation of red blood cells in the perfusate, since the artificial surfaces can potentially cause cell damage and elicit cellular responses. Membrane gas exchangers can also remove or reduce drugs or stem cells that physicians may wish to add to the perfusate in order to treat a damaged or diseased lung. Eliminating the membrane gas exchanger and providing carbon dioxide to the perfusate via ventilation of the donor lung may allow the donor lung to be perfused for a prolonged period (e.g., greater than six hours). Furthermore, the provided techniques may facilitate the addition of red blood cells and various therapies (e.g., drugs such as antibiotics, stem cells, gene therapies, etc.) to the perfusate, which may allow diseased or damaged donor lungs that would otherwise be unsuitable for transplantation to be repaired and transplanted into a recipient.

Any of the systems, methods, techniques, and/or features disclosed herein may be combined, in whole or in part, with any other systems, methods, techniques, and/or features disclosed herein.

As used herein, the singular forms “a”, “an”, and “the” include the plural reference unless the context clearly dictates otherwise.

As used herein, “membrane gas exchanger” refers to a device capable of oxygenating and/or de-oxygenating a perfusate.

Reference to “about” or “approximately” a value or parameter herein includes (and describes) variations of that value or parameter per se. For example, description referring to “approximately X” or “about X” includes description of “X” as well as variations of “X”.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

### EVLP System

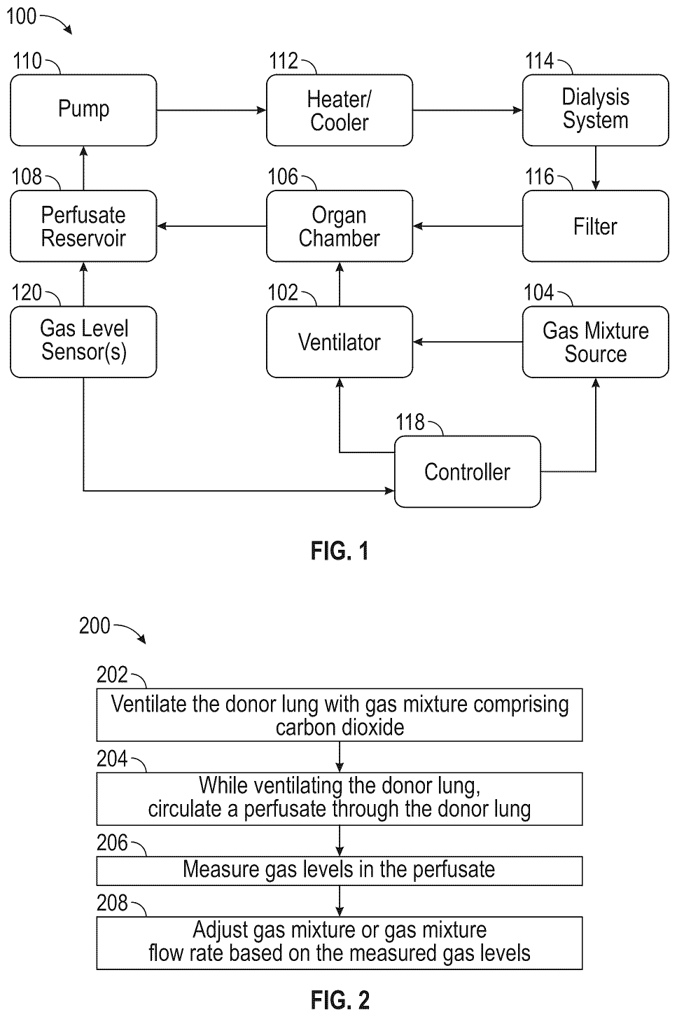

FIG. 1 provides a block diagram of an exemplary ex vivo lung perfusion (EVLP) system 100. System 100 may be used to perform EVLP on any lung suitable for transplantation. System 100 can be used to preserve a single donor lung at a time or more than a single lung at a time. For instance, system 100 may be applied simultaneously to at least 3, at least 4, at least 5, at least 6, at least 7, at least 8, at least 9, or at least 10 donor lungs or pairs of donor lungs. Unlike conventional EVLP systems, system 100 may not have a membrane gas exchanger, as discussed further below.

As shown in FIG. 1, system 100 may include a ventilator 102, a gas mixture source 104, an organ chamber 106, a perfusate reservoir 108, a pump 110, a heater/cooler 112, a dialysis system 114, a filter 116, or combinations thereof. System 100 may optionally include a UVC irradiator that can inactivate microorganisms in the perfusate. Each of the components of the system may be connected via one or more fluid conduits to form various fluid paths. The fluid conduits may be lengths of flexible tubing made from materials such as plastic or silicone. In some embodiments, the fluid conduits may be fluidly connected to one or more inlets and/or outlets on the donor organ via cannulae or other suitable connections. The fluid conduits may also fluidly connect other components in the system in a closed-circuit configuration so as to define a perfusion circuit. The perfusion circuit may not have a membrane gas exchanger, or it may bypass a membrane gas exchanger of the system. Examples of each of these components are described in detail below.

Perfusate reservoir 108 may store perfusate and/or deliver perfusate to one or more organs held in organ chamber 106. Using pump 110, system 100 may circulate perfusate from perfusate reservoir 108 through the donor lung(s). The perfusate may pass through the organ(s) numerous times and may be replaced periodically. For example, the perfusate may be replaced after a certain number of passes or after it has been recirculating for a specific amount of time (e.g., every thirty minutes, every hour, or every two hours). Additional perfusate may also be added to the system at similar time intervals.

Any suitable perfusate may be used to perfuse the donor lung. The perfusate can have an osmolality between about 270 mOsm/kg and 325 mOsm/kg. In some embodiments, the perfusate has an osmolality of less than or equal to 270, 280, 290, 300, 310, 320, or 330 mOsm/kg. In some embodiments, the perfusate has an osmolality of greater than or equal to 260, 270, 280, 290, 300, 310, or 320 mOsm/kg. In some embodiments, the perfusate has an osmolality between about 260-330 mOsm/kg, between about 260-320 mOsm/kg, between about 260-310 mOsm/kg, between about 260-300 mOsm/kg, between about 260-290 mOsm/kg, between about 260-280 mOsm/kg, and/or between about 260-270 mOsm/kg.

In some embodiments, the perfusate has a pH of about 7.2, about 7.25, about 7.3, about 7.35, about 7.4, about 7.45, or about 7.5. In some embodiments, the perfusate has a pH of less than or equal to 7.3, 7.35, 7.4, 7.45, or 7.5. In some embodiments, the perfusate has a pH of greater than or equal to 7.2, 7.25, 7.3, 7.35, 7.4, or 7.45. In some embodiments, the perfusate has a pH between about 7-7.5, between about 7.1-7.5, between about 7.2-7.4, between about 7.3-7.4, or between about 7.35-7.45.

The perfusate may include one or more cellular components, or it may be acellular. A suitable perfusate for perfusing a donor lung, for example, may be a clear, sterile, non-toxic salt solution that comprises human serum albumin (HSA), dextran, and optionally glucose. The perfusate may include, for example, 50-100 g/L HSA and 1-50 g/L dextran 40. In some embodiments, the perfusate may include one or more drugs (e.g., one or more antibiotics), biologics such as proteins, nucleic acids, organelles, and/or exosomes, cellular components such as red blood cells or stem cells, and/or a gene therapy treatment. Using an acellular perfusate may be logistically simpler than using a cellular perfusate since it can be more easily handled and cleaned. Acellular perfusates may also prevent the risk of red cell lysis, which can cause injury to the donor lung. On the other hand, using cellular perfusates may allow for longer perfusion times and may be more suitable for use in a perfusion system that does not have a membrane gas exchanger.

Organ chamber 106 may comprise a clear, plastic dome configured to hold the donor lung(s) during the EVLP process and to protect the donor lung(s) from contamination. Because organ chamber 106 is clear, a user or an operator may be able to observe the donor lung(s) during EVLP.

Pump 110 may be configured to pump perfusate between two or more components in system 100. For example, pump 110 may be configured to pump perfusate from perfusate reservoir 108 to heater/cooler 112, dialysis system 114, and/or filter 116 and into the donor lung(s) in organ chamber 106. In some embodiments, system 100 includes multiple pumps 110. In some embodiments, pump 110 is a centrifugal pump. In some embodiments, pump 110 may be a roller pump.

Heater/cooler 112 may be used to warm or cool the perfusate to a set temperature. The heater/cooler 112 can allow for the temperature control of the perfusate without requiring a membrane gas exchanger, since the membrane gas exchanger typically performs this function.

In some embodiments, heater/cooler 112 is used to warm the perfusate to approximately body temperature (i.e., 34-40° C.) during normothermic perfusion. In some embodiments, the perfusate may be warmed to a temperature of greater than or equal to 30, 31, 32, 33, 34, 35, 36, 37, 38, or 39° C. In some embodiments, the perfusate may be warmed to a temperature of less than or equal to 31, 32, 33, 34, 35, 36, 37, 38, 39, or 40° C. In some embodiments, the perfusate may be warmed to a temperature between about 30-40° C., 30-39° C., 30-38° C., 30-37° C., 30-36° C., 30-35° C., 30-34° C., 30-33° C., 30-32° C., 35-40° C., 34-40° C., 36-40° C., 37-40° C., and/or 38-40° C.

In some embodiments, heater/cooler 112 may be used to cool the perfusate to a refrigeration temperature (e.g., 8-12° C.). In some embodiments, the perfusate may be cooled to a temperature of less than or equal to 2, 4, 6, 8, 10, 12, or 14° C. In some embodiments, the perfusate may be cooled to a temperature of greater than or equal to 1, 2, 4, 6, 8, 10, or 12° C. In some embodiments, the perfusate may be cooled to a temperature between about 1-14° C., 1-12° C., 1-10° C., 1-8° C., 8-10° C., 8-12° C. and/or 10-12° C.

In some embodiments, heater/cooler 112 may be connected to a heat exchanger (e.g., a disposable unit of a heat exchanger). In some embodiments, the perfusate may be gradually or incrementally cooled over a period of time so as to avoid shocking the donor organ with a sudden temperature change.

Dialysis system 114 may be used to dialyze the perfusate. Dialysis system 114 may include a dialysis filter configured to infuse a dialysate into the perfusate. For example, a dialysate may be infused into the perfusate that includes a buffer solution having lactic acid and sodium bicarbonate, as well as an electrolyte solution that includes magnesium chloride hexahydrate and sodium chloride. In some examples, the dialysate may include 0.28-0.29 g/L lactic acid, 0.10-0.11 g/L magnesium chloride hexahydrate, 58.5-59.0 g/L sodium bicarbonate, and 6.44-6.45 g/L sodium chloride. In some examples, the dialysate may include 0.284 g/L lactic acid, 0.108 g/L magnesium chloride hexahydrate, 58.8 g/L sodium bicarbonate, and 6.449 g/L sodium chloride. In some examples, the dialysate may include 1-3 g/L glucose, 0.15-0.16 g/L potassium, 0.03-0.04 g/L calcium, and one or more drugs such as heparin, solumedrol, methylprednisolone, and antibiotics (e.g., cefazolin, meropenem, levofloxacin). Optionally, the dialysate may include a total parenteral nutrition (TPN) solution having 5-25% essential and/or nonessential amino acids and/or fatty acids.

Filter 116 may be configured to remove one or more contaminants or debris from the perfusate, such as aggregates of platelets or red blood cells. For example, filter 116 may filter out the contaminants acquired by the perfusate as it flushed through the donor lung(s). Filtration by filter 116 can allow the perfusate to recirculate through the donor lung(s) a number of times on a recirculation loop. In some embodiments, filter 116 is a leukocyte filter that is configured to separate leukocytes (i.e., white blood cells) from perfusate that has passed through the donor lung(s). In some embodiments, filter 116 is an arterial filter. In some embodiments, system 100 may include an ultra-violet C (UVC) device, which can be run continuously during perfusion periods in order to prevent potential microbial contamination.

Ventilator 102 may be fluidically coupled to one or more gas mixture sources 104 (referred to herein as gas mixture source 104 for simplicity) and to one or more donor lung(s) (e.g., to a lumen of the donor lung(s), such as the trachea) contained in the organ chamber 106. The ventilator 102 may include a valve system for controlling concentrations of constituent gases provided by gas mixture source 104 (e.g., gases supplied by a medical air supply and/or an oxygen supply, as will be discussed) to control the composition of the gas mixture provided to the donor lung. The ventilator 102 may include a plurality of gas connection ports for connecting the gas mixture source 104 to the ventilator 102. The ventilator 102 may include a controller that controls the valve system. The ventilator 102 may include a user interface for enabling a user to control the ventilator 102, such as to set concentrations of one or more gases in the gas mixture provided by the ventilator 102. Optionally, the controller may be communicatively connected to one or more other system components for receiving information that the controller uses to control the concentrations of one or more gases in the gas mixture.

In some examples, gas mixture source 104 may include a medical air supply. Given that the membrane gas exchanger, which ordinarily provides carbon dioxide, may be completely absent from system 100, the medical air supply may be modified in order to provide carbon dioxide to the perfusate. The medical air supply may be configured to provide a hypoxic gas mixture to the ventilator that includes carbon dioxide and oxygen. In the hypoxic gas, the amount of oxygen may be greatly reduced when compared to conventional medical air. For example, medical air typically includes about 20-23% oxygen, but a percentage of oxygen in the hypoxic gas mixture may be between about 6% and 8% or between about 6% and 10%. In some examples, a percentage of oxygen in the hypoxic gas mixture may be approximately 5%, 6%, 7%, 8%, 9%, or 10%. In some examples, the medical air supply may be configured to provide an amount of carbon dioxide to the ventilator that may be about the same as the amount of oxygen provided. For example, the medical air supply may supply a hypoxic gas mixture including between about 6% and 8% or between about 6% and 10% carbon dioxide. In some examples, a percentage of carbon dioxide in the hypoxic gas mixture may be about 5%, 6%, 7%, 8%, 9%, or 10%. The remainder of the hypoxic gas mixture may include an inert gas such as nitrogen. The medical air supply may therefore be modified to greatly increase the amount of carbon dioxide provided in the medical air when compared to conventional medical air, in which carbon dioxide is ordinarily kept as low as possible.

Gas mixture source 104 may also include an oxygen supply. To ensure that the lungs are provided with a sufficient amount of oxygen to sustain viability during perfusion, the oxygen supply may be configured to offset the decreased oxygen in the hypoxic gas mixture. For example, the oxygen supply line may be configured to supply a gas mixture having an increased amount of oxygen relative to conventional medical air. The oxygen supply line may be configured to supply a gas mixture to the ventilator having, for example, between 25-35% oxygen, with the remainder being nitrogen. The ventilator may be configured to adjust the amount of oxygen and/or carbon dioxide that is ultimately provided to the perfusate by regulating the amount of gas supplied by the medical air supply and the oxygen supply via one or more valves. For example, an amount of the hypoxic gas mixture and/or the oxygen gas mixture provided by the medical air supply and the oxygen supply may be adjusted such that the amount of oxygen in the gas mixture that is ultimately ventilated from the ventilator (e.g., after the hypoxic gas mixture is combined with the oxygen from the oxygen supply line in the ventilator) is about 20-23% oxygen and about 5-10% carbon dioxide.

By modifying the medical air supply to supply both oxygen and carbon dioxide, this may advantageously allow for the establishment of an oxygen gradient on either side of the donor lung in the perfusion circuit. This oxygen gradient can allow for lung functionality to be studied. Although a gas mixture including such high amounts of carbon dioxide would ordinarily be toxic when administered to a living being, enough oxygen is supplemented by the oxygen supply so as to maintain the physiology of any cellular components within the perfusate.

During perfusion, the ventilator 102 may be configured to ventilate according to predefined parameters. Such parameters may include a tidal volume of about 7 mL/kg, a respiratory rate of about 7 breaths per minute, and/or a positive-end expiratory pressure of about 5 cm H₂O. The ventilation of the donor lung may provide carbon dioxide (CO₂) to the perfusate such that a membrane gas exchanger, which ordinarily provides CO₂ may be bypassed or does not need to be present in the system. The role of the CO₂ is to maintain a target range of the partial pressure of CO₂ (pCO₂) of the perfusate, which may be about 30 to 45 mmHg, about 30-35 mmHg, about 35-40 mmHg, or about 35-45 mmHg. In some examples, the perfusate may have a pCO₂ of less than or equal to about 30, about 35, about 40, or about 45 mmHg. In some examples, the perfusate may have a pCO₂ of greater than or equal to about 30, 32, 34, 36, 38, 40, or 42 mmHg. In some examples, the perfusate may have a pCO₂ of less than or equal to about 45 mmHg, 43 mmHg, 41 mmHg, 39 mmHg, 37 mmHg, 35 mmHg, 33 mmHg, or 31 mmHg. As opposed to conventional systems, which may utilize a membrane gas exchanger to regulate the pCO₂ of the perfusate, this function may be performed by ventilator 102.

As mentioned above, the gas mixture leaving ventilator 102 and entering the perfusate can include oxygen (O₂). In some embodiments, a percentage of oxygen in the gas mixture leaving the ventilator 102 and entering the perfusate is between about 10% and 30%, between about 12% and 28%, between about 14% and 26%, between about 15% and 25%, or between about 20% and 23%. In some embodiments, a percentage of oxygen in the gas mixture leaving the ventilator 102 and entering the perfusate is approximately 18%, 19%, 20%, 21%, 22%, or 23%. In some embodiments, the gas mixture leaving the ventilator 102 and entering the perfusate comprises less than or equal to about 20%, 25%, or 30% oxygen. In some embodiments, the gas mixture leaving the ventilator 102 and entering the perfusate comprises greater than or equal to about 15%, 20%, or 25% oxygen. The amount of oxygen in the gas mixture may be selected and/or adjusted to maintain a target range of the pCO₂ of the perfusate (e.g., about 35-45 mmHg). On the other hand, the partial pressure of oxygen (pO₂) of the perfusate may fluctuate, but it is typically between about 100-150 mmHg.

The gas mixture leaving the ventilator 102 and entering the perfusate can include carbon dioxide (CO₂). In some embodiments, a percentage of carbon dioxide in the gas mixture is between about 1% and 15%, between about 1% and 14%, between about 2% and 13%, between about 3% and 12%, between about 4% and 11%, or between about 5% and 10%. In some embodiments, a percentage of carbon dioxide in the gas mixture is approximately 6%, 7%, 8%, or 9%. In some embodiments, the gas mixture comprises less than or equal to about 4%, 8%, 12%, or 16% carbon dioxide. In some embodiments, the gas mixture comprises greater than or equal to about 1%, 5%, or 9% carbon dioxide. The pCO₂ that ultimately ends up in the perfusate may vary, but the pCO₂ may generally be maintained between about 35-45 mmHg.

The gas mixture leaving the ventilator 102 and entering the perfusate can include nitrogen (N₂). The nitrogen may be used as a balance gas (e.g., an inert gas) such that nitrogen makes up the remaining composition of the gas mixture that leaves the ventilator 102 besides carbon dioxide and oxygen. In some embodiments, a percentage of nitrogen in the gas mixture is between about 50% and 90%, between about 55% and 85%, between about 60% and 80%, or between about 65% and 75%. In some embodiments, a percentage of nitrogen in the gas mixture is approximately 68%, 69%, 70%, 71%, 72%, or 73%. In some embodiments, a percentage of nitrogen in the gas mixture is less than or equal to about 55%, 60%, 65%, 70%, 75%, 80%, or 85%. In some embodiments, a percentage of nitrogen in the gas mixture is greater than or equal to about 50%, 55%, 60%, 65%, 70% 75%, or 80%.

System 100 may include one or more sensors 120 configured to measure the levels (e.g., amounts) of one or more gases in the perfusate. These sensors may include, for example, pO₂ and/or pCO₂ sensors. Gas level measurements may be performed periodically or upon receipt of an appropriate command from a user. Based on the gas level measurements, characteristics of the gas mixture may be adjusted. The relative amounts of the constituent gases of the gas mixture may be adjustable at gas mixture source 104 and/or ventilator 102. Flow properties of the gas mixture through the donor lung(s) (e.g., the flow rate) may be adjustable at ventilator 102. Adjustments may be performed manually (e.g., using one or more controls included with gas mixture source 104 or ventilator 102) or automatically by a controller 118 that is coupled to both gas level sensor(s) 120 and to ventilator 102.

Controller 118 may include one or more processors, for example one or more central processing units (CPUs), one or more graphical processing units (GPUs), or any other suitable processors. The processors may be configured to interface with gas mixture source 104 and/or ventilator 102 in order to make adjustments to the composition of the gas mixture that is delivered to the donor lungs. A computer program that configures the processors to control gas mixture source 104 and/or ventilator 102 may be stored in a non-transitory, computer readable storage medium such as a disk, a flash drive, a hard drive, read-only memory (ROM), random access memory (RAM), or an application specific integrated circuit (ASIC). Controller 118 may include a user interface (e.g., a graphical user interface displayed on a monitor or other screen) and one or more user input devices or controls (e.g., a keyboard, buttons, etc.).

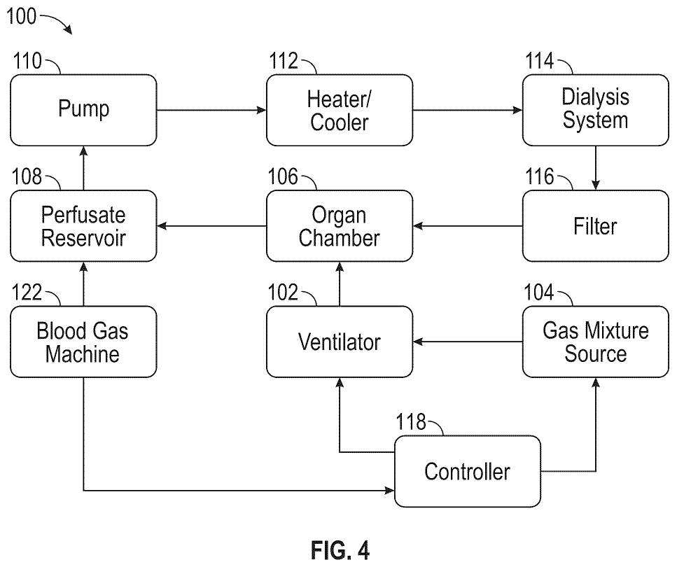

In some examples, as shown in FIG. 4, sensors 120 may be implemented in system 100 as part of a blood gas machine 122. The blood gas machine 122 may measure the composition of various gases from samples taken from the perfusate. The blood gas machine 122 may be in communication with controller 118. The blood gas machine 122 may transmit data regarding the composition of gases in the perfusate to the controller 118, which may control the concentrations of nitrogen, carbon dioxide, and/or oxygen in the gas mixture based on the data received from the blood gas machine. For example, the controller 118 may be configured to adjust the concentrations of carbon dioxide and/or oxygen in the gas mixture upon determining that the partial pressure of one or both of these gases in the perfusate falls outside of a predefined physiologically acceptable range (e.g., a pCO₂ outside of the 35-45 mmHg range). In some examples, controller 118 may be part of ventilator 102.

### EVLP Method

FIG. 2 provides an exemplary EVLP method 200. Various steps of method 200 may be performed following the surgical harvesting of a donor lung from a donor. In some embodiments of method 200, one or more of the steps shown in FIG. 2 may be combined. In other embodiments of method 200, one or more steps shown in FIG. 2 may be reordered. Optionally, one or more of the steps of method 200 shown in FIG. 2 may be omitted. Method 200 may be executed using an EVLP system such as system 100 shown in FIG. 1.

In step 202, a donor lung may be ventilated with a gas mixture. Ventilating the donor lung with the gas mixture may cause oxygenation and/or deoxygenation of the donor lung, and in turn, the perfusate, based on the composition of the gas mixture. The gas mixture may include oxygen, nitrogen, and carbon dioxide. While the donor lung is ventilated with the gas mixture, a perfusate may be circulated through the donor lung simultaneously in step 204. In some embodiments, the perfusate is warmed to a temperature of about 34-40° C. (e.g., using a heater/cooler such as heater/cooler 112 shown in FIG. 1), dialyzed (e.g., using a dialysis system such as dialysis system 114 shown in FIG. 1), and/or filtered (e.g., using a filter such as filter 116 shown in FIG. 1) during circulation.

Gas levels in the perfusate may be measured at step 206 using one or more sensors, e.g., sensors 120. At step 208, the amounts of the gas mixture's constituent gases and/or the flow of the gas mixture may be adjusted based on the measurements of the gas levels determined at step 206. Adjustments may be made manually or automatically. In some examples, steps 206 and 208 are performed automatically, such as by a blood gas machine. Step 208 may include, in response to the blood gas machine measuring a pO₂ and/or pCO₂ falling outside of a predefined physiologically acceptable range (e.g., a pCO₂ outside of the 35-45 mmHg range), controlling the gas mixture source 104 (e.g., controlling the medical air supply and/or the oxygen supply manually or by a ventilator and/or blood gas machine) to adjust the amounts carbon dioxide and/or oxygen in the gas mixture until the pO₂ and/or pCO₂ levels are within the predefined physiologically acceptable range.

In some embodiments, method 200 may be performed using a cell-based perfusate (e.g., a blood-based perfusate containing red blood cells or other cellular components). In some embodiments, method 200 may be performed using an acellular perfusate.

In some embodiments, method 200 may include procuring a donor organ, such as a donor lung or a pair of lungs using any suitable organ procurement techniques. Procuring the donor organ may include cannulating the main pulmonary artery, tying the superior and inferior vena cava, clamping the aorta, and incising the left atrial appendage. A 2 L anterograde flush can be performed in the donor at a suitable height (e.g., a height of 30 cm) above the heart. A ventilator inspiratory hold can be performed, the trachea can be clamped, and the lungs can be excised and flushed once more. As will be appreciated, other suitable methods of procuring a donor organ may be performed as part of/in addition to the above or as part of/in addition to any of the steps of method 200.

In some embodiments, method 200 may be performed prior to storing the donor lung (e.g., using a static cold storage technique) or after the donor lung has been removed from storage. In some embodiments, method 200 may include a step of storing the donor lung (e.g., in a cooler or a refrigerator). In some examples, the donor lung may be stored, optionally on ice, at a temperature of about 4° C. In some embodiments, the donor lung may be stored at a temperature of 8-12° C. (e.g., 10° C.). In some embodiments, various steps of method 200 may be performed before or after a donor organ is transported from a donor site to a different storage site or treatment location. For examples, steps 202 to 206 may be performed at a storage site and/or at a recipient site. Method 200 may also include a step for transporting the donor lung from a donor site to a perfusion site and/or from the perfusion site to a recipient site. The donor organ may optionally be kept refrigerated in a transport container at a temperature of 8-12° C. during transport.

In some embodiments, EVLP method 200 may include one or more steps from the Toronto EVLP protocol. In some embodiments, the Toronto protocol may involve an acellular or cellular perfusate, a closed left atrium, protective flows, and protective ventilation. In some embodiments, a pair of donor lungs may be placed in chamber 106. The trachea of the donor lungs may be intubated and connected to ventilator 102. The pulmonary artery (PA) and the left atrium (LA) can be cannulated, and the LA and PA can be directly connected to the perfusion system 100. In some embodiments, perfusate may be pumped through the system by pump 110 at a constant flow rate.

The Toronto protocol may also involve gradually increasing the temperature of the perfusate to about 37° C. using heater/cooler 112. When the temperature of the perfusate reaches 32° C., volume-controlled ventilation (VCV) can be initiated by ventilator 102. The perfusate flow rate can be gradually increased by pump 110 up to a maximum flow rate of 40% estimated cardiac output (CO=100 L/min). In some embodiments, EVLP may be performed for greater than or equal to 1, 2, 4, 6, 8, 10, 12, 18, or 24 hours. In some embodiments, EVLP may be performed for less than or equal to 48, 24, 18, 12, 10, 8, 6, 4, or 2 hours. In some embodiments, EVLP may be performed for about 1-14 hours, 1-12 hours, 1-10 hours, 1-8 hours, 1-6 hours, 6-12 hours, 6-10 hours, 6-8 hours, or 12-24 hours.

In some embodiments, physiological assessments of the lungs may be performed during the Toronto protocol. These assessments may include ventilator parameters (e.g., dynamic compliance, static compliance, peak airway pressure, plateau pressure) and perfusate blood gas analysis. Lungs may also be weighed prior to and after EVLP using the Toronto protocol. Net weight gain can be calculated and used to as a measure of lung edema.

More than one EVLP cycle may be performed. For example, after a first EVLP cycle, system 100 can be stored at 4-12° C. overnight and can be re-connected to the lungs for the next EVLP cycle using snap-cannulas. An ultra-violet C device can be added to the circuit and can run continuously during the perfusion periods in order to prevent potential microbial contamination. In some embodiments, method 200 may also involve transplanting the donor lungs using any suitable transplantation technique.

### EXAMPLE

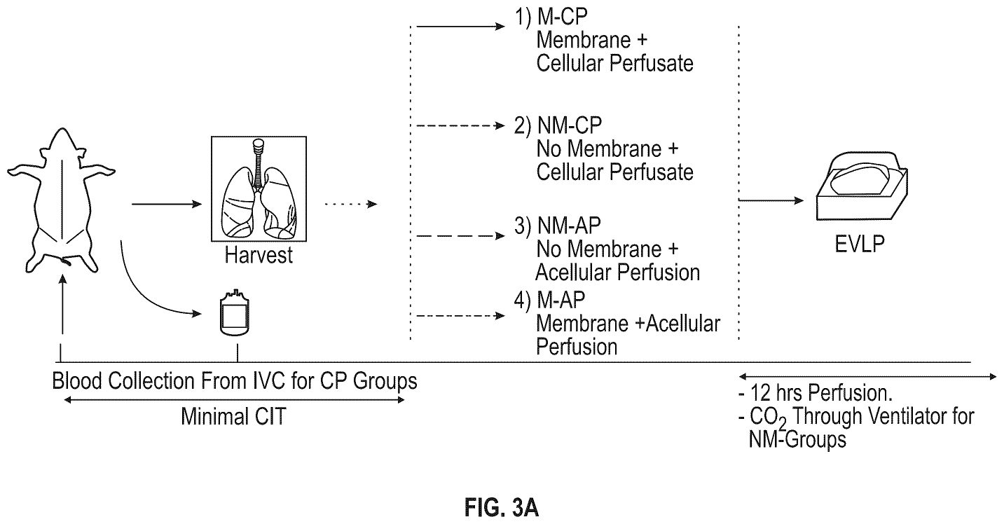

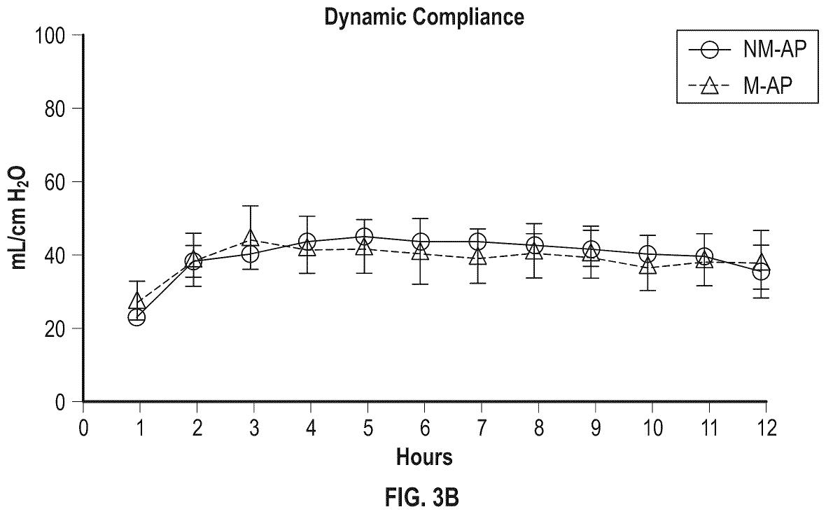

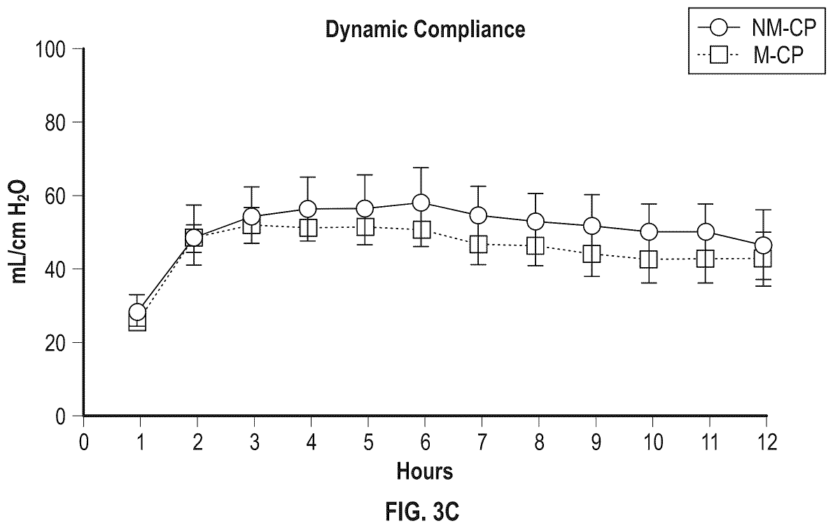

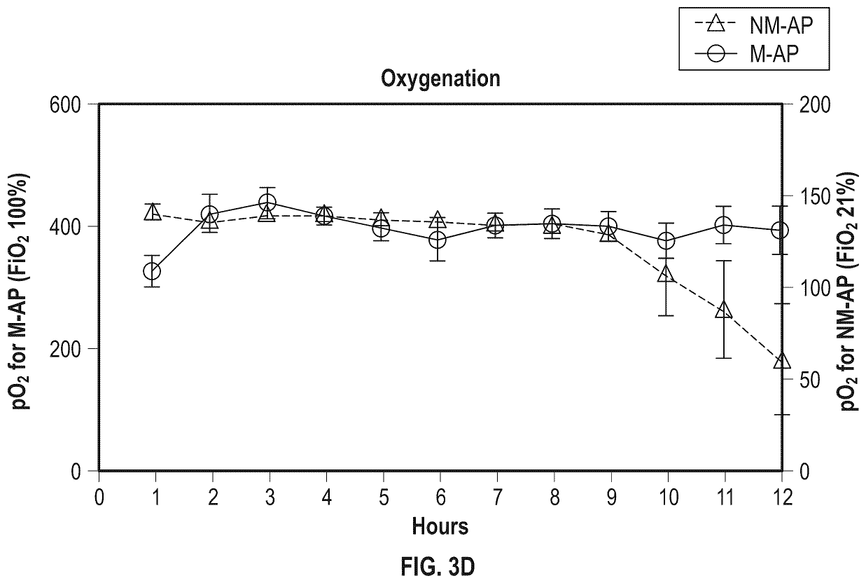

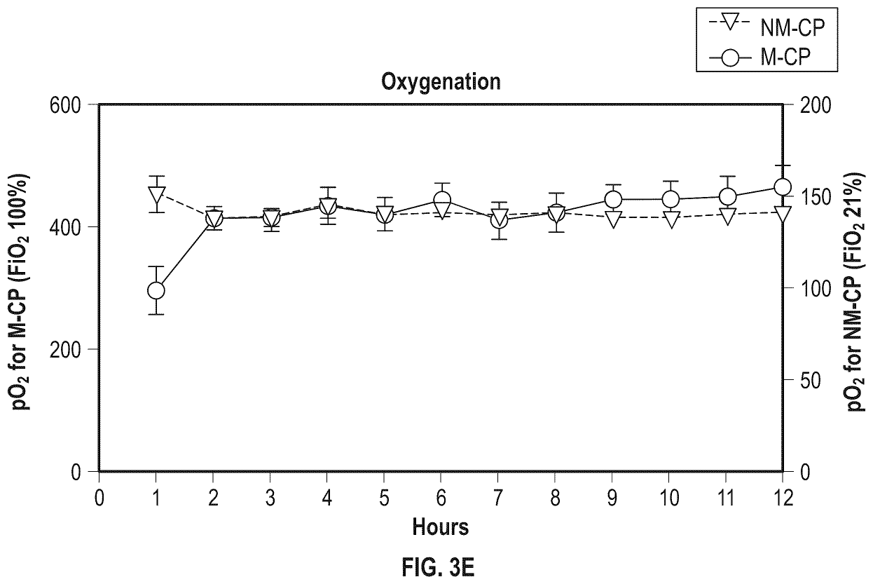

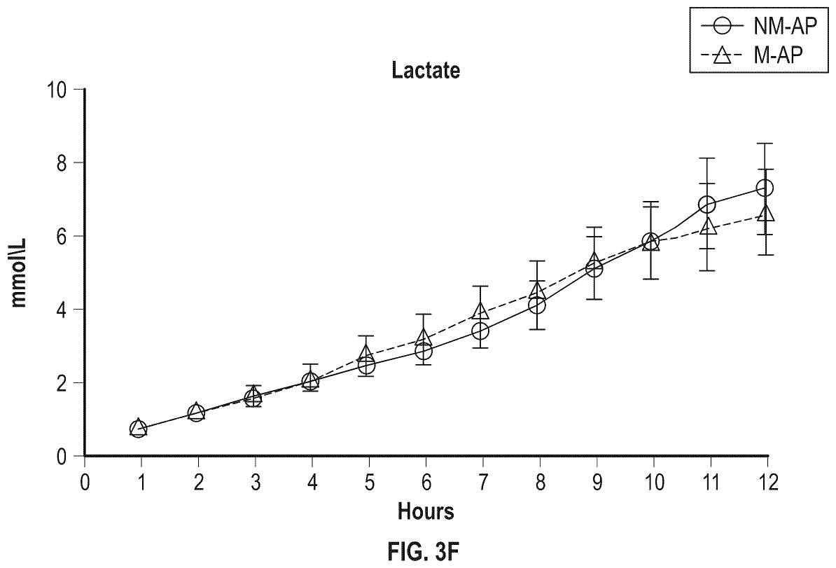

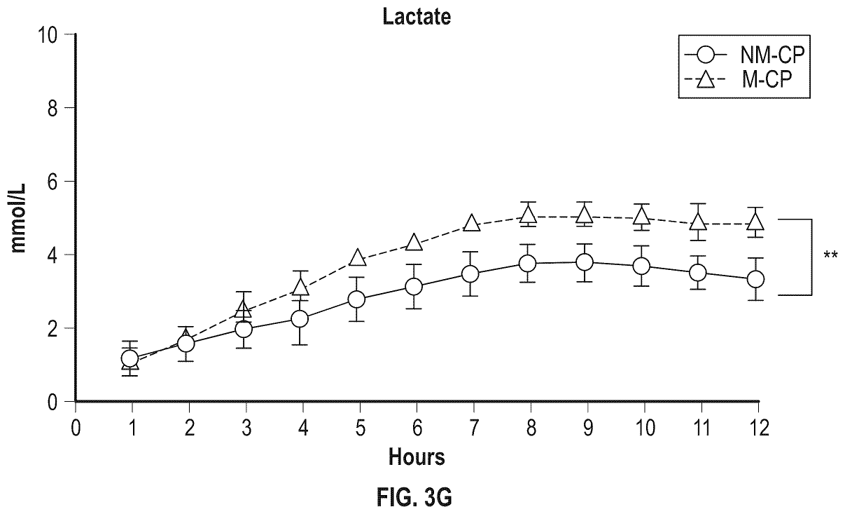

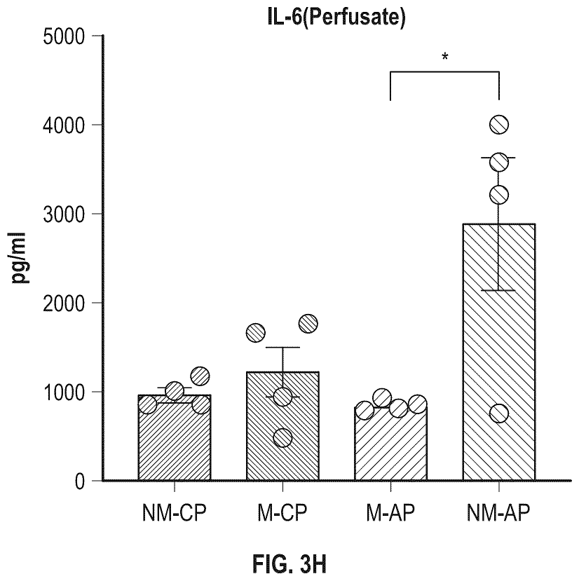

In this example, the safety and feasibility of removing the membrane gas exchanger from the EVLP system and its effect on cellular and acellular perfusion were investigated. Healthy lungs from Yorkshire pigs (n=4/group) were studied in four groups of ex vivo lung perfusion (EVLP). The experimental setup is shown in FIG. 3A, with the four groups being as follows: 1) membrane gas exchanger+cellular perfusion (M-CP); 2) no membrane gas exchanger+cellular perfusion (N-CP); 3) no membrane gas exchanger+acellular perfusion (N-AP); 4) membrane gas exchanger+acellular perfusion (M-AP).

For cellular perfusion (CP), red blood cells (RBCs) were collected from donor inferior vena cava during a cross-clamp. For acellular perfusion (AP), the Toronto EVLP protocol was employed using system 100 described above. In order to maintain physiological pCO₂ in the perfusate in the no membrane gas exchanger groups, a gas mixture of 21% O₂, 8% CO₂ and 71% N₂ was given to lungs via the ventilator. Lung functions were evaluated during 12 hours of EVLP. Perfusate samples were collected at 1 h and 12 h of EVLP for cytokine analysis. Target hematocrit of 10-15% was achieved in the cellular perfusion groups.

FIGS. 3B-3H show lung physiology data collected during the 12^{th} hour of EVLP. All results in FIGS. 3B-3H are expressed as mean plus/minus standard error of the mean. The data was analyzed using a two-way ANOVA test with Bonferroni multiple comparisons. In FIGS. 3B-3H, a single asterisk (*) represents p<0.05 and a double asterisk (**) represents p<0.01.

FIGS. 3B-3C show dynamic compliance data, with FIG. 3B showing dynamic compliance data for the acellular perfusion groups and FIG. 3C showing dynamic compliance data for the cellular perfusion groups. As shown in FIGS. 3B-3C, dynamic compliance showed a similar stable trend in both the membrane gas exchanger groups and no membrane gas exchanger groups for both cellular and acellular perfusion.

FIGS. 3D-3E show lung oxygenation data, with the left axis showing the perfusate partial pO₂ measured at FiO₂ of 100% for the membrane gas exchanger groups and the right axis showing pO₂ measured at FiO₂ of 21% for the no membrane gas exchanger groups. FIG. 3D corresponds to the acellular perfusion groups, while FIG. 3E corresponds to the cellular perfusion groups. The same stable trend in oxygenation was observed between both the membrane gas exchanger and no membrane gas exchanger cellular perfusion groups, as shown in FIG. 3E. However, as shown in FIG. 3D, oxygenation failure occurred in the acellular perfusion with no membrane gas exchanger group after 10 hours of EVLP. This may suggest that the use of cellular perfusate is preferable for use with an EVLP circuit that does not include a membrane gas exchanger.

FIGS. 3F-3G show perfusate lactate data. FIG. 3F corresponds to the acellular perfusion groups, while FIG. 3G corresponds to the cellular perfusion groups. As shown in FIG. 3G, there was a statistically significant decrease in lactate levels in the cellular perfusion with no membrane gas exchanger group when compared to the cellular perfusion with the membrane gas exchanger (p<0.01). However, there was no statistically significant difference in lactate levels between the acellular perfusion groups with and without the membrane gas exchanger, shown in FIG. 3F. This suggests that the lactate levels observed may be related to the oxygenation status of the organ, rather than the choice in acellular versus cellular perfusion. Additionally, when comparing FIG. 3F and 3G, lactate levels plateaued in the cellular perfusion groups compared to the acellular perfusion groups, implying a shift in metabolic activities. For example, within a living system, lactate production increases when the demand for ATP and oxygen exceeds supply. Therefore, the different lactate pattern observed in the cellular perfusion groups may imply altered tissue oxygen supply and/or metabolism when compared to the acellular perfusion groups.

FIG. 3H shows perfusate level of pro-inflammatory cytokine IL-6. As shown, there was a statistically significant increase in IL-6 levels in the acellular perfusion with no membrane gas exchanger group compared to the acellular perfusion with the membrane gas exchanger group (p<0.5). However, this difference was not observed between the cellular perfusion groups with and without the membrane gas exchanger. This further suggests that, for an EVLP system that does not have a membrane gas exchanger, it may be desirable to use a cellular perfusate as opposed to an acellular perfusate.

Taken together, these results indicate that performing EVLP in a system that does not include a membrane gas exchanger may be safe and effective for use with cellular perfusates, with potential benefits at the metabolic and cellular levels when compared to traditional systems that include a membrane gas exchanger.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. An ex vivo lung perfusion (EVLP) method comprising:
ventilating a donor lung with a gas mixture that comprises carbon dioxide; and
circulating a perfusate through a perfusion circuit and the donor lung while ventilating the donor lung, wherein the perfusion circuit does not have a membrane gas exchanger.

2. The EVLP method of claim 1, wherein the gas mixture comprises 5% to 10% carbon dioxide.

3. The EVLP method of claim 1, wherein the gas mixture comprises 8% carbon dioxide.

4. The EVLP method of claim 1, wherein the gas mixture comprises 20-23% oxygen.

5. The EVLP method of claim 1, wherein the gas mixture comprises 21% oxygen.

6. The EVLP method of claim 1, wherein the gas mixture comprises 65% to 75% nitrogen.

7. The EVLP method of claim 1, wherein the gas mixture comprises 71% nitrogen.

8. The EVLP method of claim 1, comprising:
measuring one or more gas levels in the perfusate; and
adjusting one or more gas levels in the gas mixture based on the measured one or more gas levels in the perfusate.

9. The EVLP method of claim 8, comprising adjusting a flow rate of the gas mixture through the donor lung based on the measured one or more gas levels.

10. The EVLP method of claim 1, comprising warming the perfusate to a temperature of 34-40° C.

11. The EVLP method of claim 1, comprising dialyzing the perfusate.

12. The EVLP method of claim 1, comprising refrigerating the donor lung.

13. The EVLP method of claim 1, comprising transporting the donor lung from a donor site to a perfusion site.

14. The EVLP method of claim 1, wherein the perfusate comprises a cellular component.

15. The EVLP method of claim 14, wherein the perfusate comprises red blood cells.

16. The EVLP method of claim 1, comprising:
receiving, at a ventilator, a hypoxic gas mixture from a medical air supply and an oxygen gas mixture from an oxygen supply; and
combining the hypoxic gas mixture with the oxygen gas mixture to create the gas mixture that comprises carbon dioxide.

17. An ex vivo lung perfusion (EVLP) system comprising:
a ventilator configured to control a composition of, and ventilate a donor lung with, a gas mixture comprising carbon dioxide;
a perfusion circuit connected to the donor lung for perfusing the donor lung with a perfusate, wherein the perfusion circuit does not have a membrane gas exchanger; and
a pump configured to circulate the perfusate through the perfusion circuit and the donor lung while the donor lung is being ventilated.

18. The EVLP system of claim 17, wherein the ventilator is configured to control the composition of the gas mixture such that the gas mixture comprises 5% to 10% carbon dioxide.

19. The EVLP system of claim 17, wherein the ventilator is configured to control the composition of the gas mixture such that the gas mixture comprises 8% carbon dioxide.

20. The EVLP system of claim 17, wherein the ventilator is configured to control the composition of the gas mixture such that the gas mixture comprises 20% to 23% oxygen.

21. The EVLP system of claim 17, wherein the ventilator is configured to control the composition of the gas mixture such that the gas mixture comprises 21% oxygen.

22. The EVLP system of claim 17, wherein the ventilator is configured to control the composition of the gas mixture such that the gas mixture comprises 65% to 75% nitrogen.

23. The EVLP system of claim 17, wherein the ventilator is configured to control the composition of the gas mixture such that the gas mixture comprises 71% nitrogen.

24. The EVLP system of claim 17, comprising one or more sensors configured to measure one or more gas levels in the perfusate.

25. The EVLP system of claim 24, comprising a controller coupled to the one or more sensors and the ventilator, wherein the controller is configured to cause the ventilator to adjust one or more gas levels in the gas mixture based on the measured one or more gas levels in the perfusate.

26. The EVLP system of claim 25, wherein the controller is configured to cause the ventilator to adjust a flow rate of the gas mixture through the donor lung based on the measured one or more gas levels in the perfusate.

27. The EVLP system of claim 17, comprising a heater configured to warm the perfusate to a temperature of 34-40° C.

28. The EVLP system of claim 17, comprising a dialysis unit configured to dialyze the perfusate.

29. The EVLP system of claim 17, comprising a filter configured to filter the perfusate.

30. The EVLP system of claim 29, wherein the filter is configured to filter a perfusate comprising a cellular component.

31. The EVLP system of claim 30, wherein the cellular component comprises red blood cells.

32. The EVLP system of claim 31, comprising a blood gas machine configured to measure one or more gas levels in the perfusate.

33. The EVLP system of claim 17, wherein the ventilator is configured to:
receive a hypoxic gas mixture from a medical air supply and an oxygen gas mixture from an oxygen supply; and
combine the hypoxic gas mixture with the oxygen gas mixture to create the gas mixture that comprises carbon dioxide.
